(19) United States
(12) Patent Application Publication
(10) Pub. No.: US 2023/0268750 A1
(43) Pub. Date: Aug. 24, 2023

(54) POWER CHARGING DEVICE

(71) Applicant: Thomas Shaver, Braidwood, IL (US)

(72) Inventor: Thomas Shaver, Braidwood, IL (US)

(21) Appl. No.: 17/677,369

(22) Filed: Feb. 22, 2022

(51) Int. Cl. H02J 7/00; H02J 7/02; H01R 24/60

(52) U.S. Cl. CPC H02J 7/0045; H02J 7/02; H01R 24/60; H02J 7/0044

(57) ABSTRACT

A power charging device to removably connect to a power outlet, the power charging device including a main body to receive power while connected to the power outlet, a lighting receiving inlet disposed within at least a portion of the main body to receive a lightning connector therein, a USB-C receiving inlet disposed within at least a portion of the main body to receive a USB-C connector therein, and a USB receiving inlet disposed within at least a portion of the main body to receive a USB connector therein.

### BACKGROUND

### 1. Field

The present general inventive concept relates generally to charging, and particularly, to a power charging device.

### 2. Description of the Related Art

Charging devices are important accessories that facilitate charging for a wide variety of electronic devices. Most electronic devices that are portable, such as a mobile device, a cell phone, a tablet computer, and/or a laptop computer use a battery as a source of power. Typically, a charging device has a single type of outlet to receive a connection. For example, charging devices will generally connect to either a universal serial bus Type-C (USB-C) or a lightning connector.

The limitation of having only two types of connectors requires a user with different electronic devices to carry different power cords at all times. However, this situation can be a problem if the user does not have access to both power cords.

Therefore, there is a need for a power charging device that can receive any type of power connector, such that any electronic device can be charged.

### SUMMARY

The present general inventive concept provides a power charging device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a power charging device to removably connect to a power outlet, the power charging device including a main body to receive power while connected to the power outlet, a lighting receiving inlet disposed within at least a portion of the main body to receive a lightning connector therein, a USB-C receiving inlet disposed within at least a portion of the main body to receive a USB-C connector therein, and a USB receiving inlet disposed within at least a portion of the main body to receive a USB connector therein.

At least one of the lightning receiving inlet, the USB-C receiving inlet, and the USB receiving inlet may disperse power therefrom while the main body is connected to the power outlet.

The power charging device may further include a plurality of inlet barriers movably disposed within at least a portion of the main body to cover at least a portion of at least one of the lightning receiving inlet, the USB-C receiving inlet, and the USB receiving inlet and allow access to at least one of the lightning receiving inlet, the USB-C receiving inlet, and the USB receiving inlet in a second position.

At least one of the plurality of inlet barriers may be prevented from moving in response to an incorrect connector being in contact thereof.

The power charging device may further include a control unit disposed within at least a portion of the main body to detect the dimensions of the connector in contact with at least one of the plurality of inlet barriers, and to open or keep the plurality of inlet barriers closed based on at least one of the lightning connector, the USB-C connector, and the USB connector attempting to be inserted into at least one of the lightning receiving inlet, the USB-C receiving inlet, and the USB receiving inlet.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a side perspective view of a power charging device, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the FIGURES, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Power Charging Device 100
Main Body 110
Lightning Receiving Inlet 120
Universal Serial Bus Type-C (USB-C) Receiving Inlet 130
Universal Serial Bus (USB) Receiving Inlet 140
Inlet Barriers 150
Control Unit 160

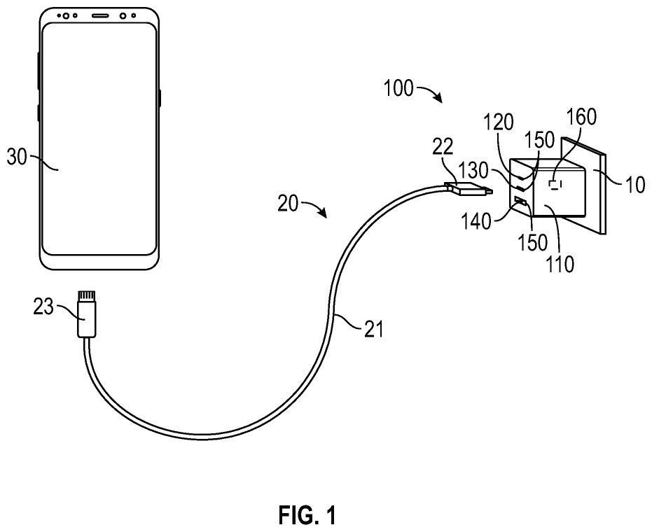

FIG. 1 illustrates a side perspective view of a power charging device 100, according to an exemplary embodiment of the present general inventive concept.

The power charging device 100 may be constructed from at least one of metal, plastic, glass, and rubber, etc., but is not limited thereto.

The power charging device 100 may include a main body 110, a lighting receiving inlet 120, a USB-C receiving inlet 130, a USB receiving inlet 140, a plurality of inlet barriers 150, and a control unit 160, but is not limited thereto.

Referring to FIG. 1, the main body 110 is illustrated to have a rectangular prism shape. However, the main body 110 may be rectangular, circular, cylindrical, triangular, pentagonal, hexagonal, heptagonal, octagonal, or any other shape known to one of ordinary skill in the art, but is not limited thereto.

The main body 110 may be a plug that is removably connected (i.e., inserted) into a power outlet 10. Accordingly, the main body 110 may have a plurality of prongs that are removably inserted into the power outlet 10.

The lighting receiving inlet 120 may be disposed on and/or within at least a portion of the main body 110. The lightning receiving inlet 120 may have dimensions (e.g., a size and/or a shape) corresponding to dimensions of a lightning port. In other words, the lightning receiving inlet 120 may receive a lightning connector therein. As such, the lightning receiving inlet 120 may disperse power therefrom to the lightning connector.

The USB-C receiving inlet 130 may be disposed on and/or within at least a portion of the main body 110. The USB-C receiving inlet 130 may have dimensions (e.g., a size and/or a shape) corresponding to dimensions of a USB-C port. In other words, the USB-C receiving inlet 130 may receive a USB-C connector therein. As such, the USB-C receiving inlet 130 may disperse power therefrom to the USB-C connector.

The USB receiving inlet 140 may be disposed on and/or within at least a portion of the main body 110. The USB receiving inlet 140 may have dimensions (e.g., a size and/or a shape) corresponding to dimensions of a USB port (e.g., USB 1.0 to USB 3.1). In other words, the USB receiving inlet 140 may receive a USB connector therein. As such, the USB receiving inlet 140 may disperse power therefrom to the USB connector.

Referring again to FIG. 1, a power cord 20 may include a cord body 21, a USB-C connector 22, and a lightning connector 23. The USB-C connector 22 may be removably connected within the USB-C receiving inlet 130. Thereafter, the lightning connector 23 may be removably connected to a mobile device 30. As such, the mobile device 30 may receive power and/or charge in response to connecting to the power cord 20 and/or the main body 110 while the main body 110 is connected to the power outlet 10.

Alternatively, the lightning connector 23 may be removably connected within the lightning receiving inlet 120. The USB-C connector 22 may be removably connected to another mobile device 30. Accordingly, the another mobile device 30 may receive power and/or charge in response to connecting to the power cord 20 and/or the main body 110 while the main body 110 is connected to the power outlet 10.

The plurality of inlet barriers 150 may be movably (i.e., slidably) disposed within at least a portion of the main body 110. Moreover, the plurality of inlet barriers 150 may cover at least a portion of the lightning receiving inlet 120, the USB-C receiving inlet 130, and/or the USB receiving inlet 140 in a first position and allow access to the lightning receiving inlet 120, the USB-C receiving inlet 130, and/or the USB receiving inlet 140 in a second position. The plurality of inlet barriers 150 may move (i.e., open) in response to receiving (i.e., being contacted by) the lightning connector 23, the USB-C connector 22, and/or a USB connector thereon, corresponding to the lightning receiving inlet 120, the USB-C receiving inlet 130, and/or the USB receiving inlet 140, respectively. However, the plurality of inlet barriers 150 may be prevented from moving (i.e., remain closed) in response to a connector that does not match (i.e., an incorrect connector) a receiving inlet, contacting the inlet barrier 150. For example, the inlet barrier 150 covering the USB-C receiving inlet 130 may remain closed in response to the lightning connector 23 and/or the USB connector contacting the inlet barrier 150. The same principle of operation may be used for the plurality of inlet barriers 150 covering the lightning receiving inlet 120 and/or the USB receiving inlet 140.

The control unit 160 may include a processing unit and a sensor, but is not limited thereto.

The processing unit (or central processing unit, CPU) of the control unit 160 may include electronic circuitry to carry out instructions of a computer program by performing basic arithmetic, logical, control and input/output (I/O) operations specified by the instructions. The processing unit of the control unit 160 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit of the control unit 160 may also include a microprocessor and a microcontroller.

The control unit 160 may be disposed within at least a portion of the main body 110. The control unit 160 may detect the dimensions of the connector (i.e., a type of connector) in contact with at least one of the plurality of inlet barriers 150. Additionally, the control unit 160 may determine whether the connector in contact with at least one of the plurality of inlet barriers 150 corresponds to the appropriate receiving inlet. As described above with respect to the plurality of inlet barriers 150, the control unit 160 may determine whether to allow the plurality of inlet barriers 150 to open and/or remain closed based on the connector attempting to be inserted into the lightning receiving inlet 120, the USB-C receiving inlet 130, and/or the USB receiving inlet 140.

Therefore, the power charging device 100 may facilitate charging of the mobile device 30 and/or the another mobile device 30 by minimizing a number of power cords required to connect. As such, the power charging device 100 may simultaneously charge multiple devices with different connection ports.

The present general inventive concept may include a power charging device 100 to removably connect to a power outlet 10, the power charging device 100 including a main body 110 to receive power while connected to the power outlet 10, a lighting receiving inlet 120 disposed within at least a portion of the main body 110 to receive a lightning connector 23 therein, a USB-C receiving inlet 130 disposed within at least a portion of the main body 110 to receive a USB-C connector 22 therein, and a USB receiving inlet 140 disposed within at least a portion of the main body 110 to receive a USB connector therein.

At least one of the lightning receiving inlet 120, the USB-C receiving inlet 130, and the USB receiving inlet 140 may disperse power therefrom while the main body 110 is connected to the power outlet 10.

The power charging device 100 may further include a plurality of inlet barriers 150 movably disposed within at least a portion of the main body 110 to cover at least a portion of at least one of the lightning receiving inlet 120, the USB-C receiving inlet 130, and the USB receiving inlet 140 and allow access to at least one of the lightning receiving inlet 120, the USB-C receiving inlet 130, and the USB receiving inlet 140 in a second position.

At least one of the plurality of inlet barriers 150 may be prevented from moving in response to an incorrect connector being in contact thereof.

The power charging device 100 may further include a control unit 160 disposed within at least a portion of the main body 110 to detect the dimensions of the connector in contact with at least one of the plurality of inlet barriers 150, and to open or keep the plurality of inlet barriers 150 closed based on at least one of the lightning connector 23, the USB-C connector 22, and the USB connector attempting to be inserted into at least one of the lightning receiving inlet 120, the USB-C receiving inlet 130, and the USB receiving inlet 140.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A power charging device to removably connect to a power outlet, the power charging device comprising:
a main body to receive power while connected to the power outlet;
a lighting receiving inlet disposed within at least a portion of the main body to receive a lightning connector therein;
a USB-C receiving inlet disposed within at least a portion of the main body to receive a USB-C connector therein; and
a USB receiving inlet disposed within at least a portion of the main body to receive a USB connector therein.

2. The power charging device of claim 1, wherein at least one of the lightning receiving inlet, the USB-C receiving inlet, and the USB receiving inlet disperse power therefrom while the main body is connected to the power outlet.

3. The power charging device of claim 1, further comprising:
a plurality of inlet barriers movably disposed within at least a portion of the main body to cover at least a portion of at least one of the lightning receiving inlet, the USB-C receiving inlet, and the USB receiving inlet and allow access to at least one of the lightning receiving inlet, the USB-C receiving inlet, and the USB receiving inlet in a second position.

4. The power charging device of claim 3, wherein at least one of the plurality of inlet barriers is prevented from moving in response to an incorrect connector being in contact thereof.

5. The power charging device of claim 4, further comprising:
a control unit disposed within at least a portion of the main body to detect the dimensions of the connector in contact with at least one of the plurality of inlet barriers, and to open or keep the plurality of inlet barriers closed based on at least one of the lightning connector, the USB-C connector, and the USB connector attempting to be inserted into at least one of the lightning receiving inlet, the USB-C receiving inlet, and the USB receiving inlet.
